(19) United States
(12) Patent Application Publication
(10) Pub. No.: US 2023/0174719 A1
(43) Pub. Date: Jun. 8, 2023

(54) Polyamideimide Precursor Composition, Method for Producing the Same, and Use Thereof

(71) Applicants: SK Innovation Co., Ltd., Seoul (KR); SK ie technology Co., Ltd., Seoul (KR)

(72) Inventors: Cheol Min Yun, Daejeon (KR); Hye Jin Park, Daejeon (KR)

(21) Appl. No.: 17/896,295

(22) Filed: Aug. 26, 2022

(30) Foreign Application Priority Data
Aug. 27, 2021 (KR) 10-2021-0113615
Aug. 30, 2021 (KR) 10-2021-0114391

(51) Int. Cl. C08G 73/14; C08J 5/18

(52) U.S. Cl. CPC C08G 73/14; C08J 5/18; C08J 2379/08

(57) ABSTRACT

Provided are a polyamideimide precursor composition, a method for producing the same, and a use thereof. A polyamideimide film formed from the polyamideimide precursor composition according to one embodiment has excellent visibility with no optical stain while colorless and transparent optical properties are not deteriorated, has excellent thermal resistance and mechanical properties, has excellent flexibility and bending properties, and thus, may be usefully applied to a polyamideimide film for replacing tempered glass and a display device including the same.

### CROSS-REFERENCE TO RELATED APPLICATIONS

This application claims priority to Korean Patent Application No. 10-2021-0113615, filed Aug. 27, 2021 and Korean Patent Application No. 10-2021-0114391, filed Aug. 30, 2021, the disclosures of which are hereby incorporated by reference in their entireties.

### BACKGROUND OF THE INVENTION

### Field of the Invention

The following disclosure relates to a polyamideimide precursor composition, a method for producing the same, and a use thereof.

### Description of Related Art

In recent years, it has been important to make a display device lighter, slimmer, and more flexible. Since a glass substrate which has been widely used in a conventional display is heavy, brittle, inflexible, and difficult to be subjected to a continuous process, a study for applying a polymer substrate which replaces the glass substrate and has an advantage of being light, flexible, and capable of a continuous process to a flexible display is being actively conducted. Among them, a polyamideimide (PAI) which is a polymer which is easily synthesized and has excellent thermal resistance, chemical resistance, and the like is mainly used.

A substrate material for a next-generation display device should have excellent optical properties, and also, have improved flexibility and mechanical properties for application to a foldable or flexible display device. Furthermore, a flexible device involves a high temperature process, and, in particular, since a process temperature of an organic light emitting diode (OLED) device using a low temperature polysilicon (LIPS) process is 350° C. or higher or approaches 500° C., excellent thermal resistance is required.

Meanwhile, the color of common polyamideimide is brown or yellow, and the main cause thereof is a charge transfer complex (CTC) by intramolecular and intermolecular interactions of polyamideimide. This lowers a light transmittance and increases birefringence of a polyamideimide film to affect viewing sensibility of a display device.

In order to solve the problems, monomers having various structures are combined or changed to decrease the CTC effect, thereby producing a colorless and transparent polyamideimide. However, optical properties and thermal resistance are in a trade-off relationship with each other, and the attempt is bound to produce extremely general results of decreased functionality or deteriorated thermal resistance, in spite of better optical properties of polyamideimide. Thus, studies for improving color transparency and optical properties are continued within a range which does not significantly reduce thermal resistance and mechanical properties of polyamideimide, but there is a limitation to satisfying all of them.

### SUMMARY OF THE INVENTION

An embodiment is directed to providing a polyamideimide precursor composition including a structural unit derived from a diamine, a structural unit derived from a dianhydride, and a structural unit derived from a diacid dichloride.

Another embodiment is directed to providing a polyamideimide film which implements both excellent optical properties and excellent thermal resistance.

Another embodiment is directed to providing a method for producing the polyamideimide film according to the embodiment.

Another embodiment is directed to providing a method for producing a polyamideimide precursor composition according to the embodiment.

Still another embodiment is directed to providing a device for display including the polyamideimide film according to the embodiment and a cover window for a display device.

In one general aspect, a polyamideimide precursor composition includes: a structural unit derived from a diamine, a structural unit derived from a dianhydride, and a structural unit derived from a diacid dichloride,

wherein the structural unit derived from a diamine includes a structural unit derived from a compound represented by the following Chemical Formula 1; the structural unit derived from a dianhydride includes a structural unit derived from a compound represented by the following Chemical Formula 2; and the structural unit derived from a diacid dichloride includes a structural unit derived from a compound represented by the following Chemical Formula 3 and a structural unit derived from a compound represented by the following Chemical Formula 4:

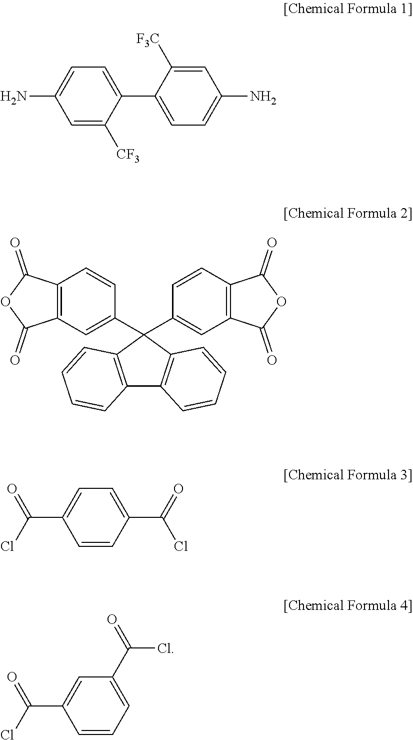

In another general aspect, a polyamideimide film formed from the polyamideimide precursor composition according to the embodiment is provided.

In another general aspect, a method for producing a polyamideimide film includes: applying the polyamideimide precursor composition according to the embodiment on a substrate and then performing a heat treatment.

In another general aspect, a method for producing the polyamideimide precursor composition according to the embodiment is provided.

In still another general aspect, a cover window for a display device including the polyamideimide film according to the embodiment and a display device are provided.

Other features and aspects will be apparent from the following detailed description, the drawings, and the claims.

### DESCRIPTION OF THE INVENTION

Hereinafter, one embodiment of the present disclosure will be described in detail so that a person with ordinary skill in the art described in the present specification may easily carry out the embodiment. However, one embodiment may be implemented in various different forms, and is not limited to specific examples described herein. In addition, it is not intended to limit the protection scope defined in the claims.

In addition, the technical and scientific terms used in the present specification have, unless otherwise defined, the meaning commonly understood by a person with ordinary skill in the art described in the present specification.

Throughout the present specification, unless explicitly described to the contrary, “comprising” any constituent elements will be understood to imply further inclusion of other constituent elements rather than the exclusion of any other constituent elements.

Hereinafter, unless otherwise particularly defined in the present specification, a “combination thereof” refers to a mixture or copolymerization of constituents.

Hereinafter, unless otherwise particularly defined in the present specification, the term “A and/or B” in the present specification may refer to an embodiment including both A and B or an embodiment selecting one of A and B.

Hereinafter, unless otherwise particularly defined in the present specification, a “polymer” may include an oligomer and a polymer, and may include a homopolymer and a copolymer. The copolymer may include an alternating polymer, a block copolymer, a random copolymer, a branched copolymer, a crosslinked copolymer, or all of them.

Hereinafter, unless otherwise particularly defined in the present specification, a “polyamic acid” refers to a polymer including a structural unit having an amic acid moiety, and a “polyamideimide” may refer to a polymer including a structural unit having an amide moiety and an imide moiety.

Hereinafter, unless otherwise particularly defined in the present specification, a polyamideimide film may be a film including a polyamideimide, and specifically, may be a high thermal resistant film produced by solution polymerizing a dianhydride compound and a diacid dichloride in a diamine compound solution to produce a polyamic acid, which is then imidized by cyclizing and dehydrating at a high temperature.

Hereinafter, unless otherwise particularly defined in the present specification, a “Mura phenomenon” may be interpreted as including all distortion phenomena by light which may be caused at a certain angle. For example, distortion by light, such as a black out phenomenon in which a screen looks black, a hot spot phenomenon, or a rainbow phenomenon having an iridescent stain, in a display device including a polyamideimide film, may be included.

Hereinafter, unless otherwise particularly defined in the present specification, it will be understood that when it is described that a part such as a layer, a film, a thin film, a region, or a plate is “on” or “above” another part, it may include not only the case of being “directly on” the other part but also the case of intervening another part therebetween.

Hereinafter, a polyamideimide precursor composition according to one embodiment will be described.

As a material for replacing expensive tempered glass conventionally used as a cover window for a display, a polyimide-based film drew attention, but the polyimide-based film may easily cause distortion by light. However, since on a cover window formed in the outermost part of a display device, a phenomenon occurring by light is directly visible to the naked eye, it is very important not to cause distortion by light. Thus, development of a precursor composition for producing a polyimide-based film which may fundamentally solve the problem of distortion by light is needed.

The polyamideimide precursor composition according to one embodiment includes a structural unit derived from a diamine, a structural unit derived from a dianhydride, and a structural unit derived from a diacid dichloride, wherein the structural unit derived from a diamine includes a structural unit derived from a compound represented by the following Chemical Formula 1;

the structural unit derived from a dianhydride includes a structural unit derived from a compound represented by the following Chemical Formula 2; and the structural unit derived from a diacid dichloride includes a structural unit derived from a compound represented by the following Chemical Formula 3 and a structural unit derived from a compound represented by the following Chemical Formula 4:

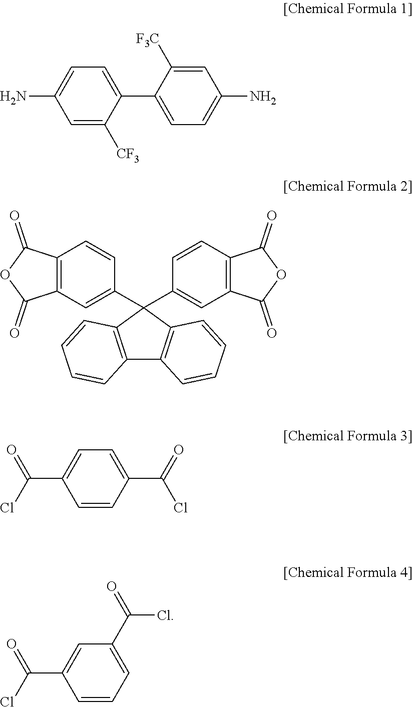

The polyamideimide precursor composition according to an exemplary embodiment may be a composition for forming a polyamideimide film.

The structural unit derived from the compound represented by Chemical Formula 3 included in the polyamideimide precursor composition according to an exemplary embodiment may be included in an amount of more than 50 mol % and less than 90 mol %, based on a total of 100 mol % of the structural unit derived from the compound represented by Chemical Formula 3 and the structural unit derived from the compound represented by Chemical formula 4. Otherwise, it may be included, for example, at more than 55 mol % and less than 90 mol %, at more than 60 mol % and less than 90 mol %, at more than 50 mol % and 88 mol % or less, or at more than 50 mol % and 85 mol % or less. Otherwise, a mole ratio between the structural unit derived from the compound represented by Chemical Formula 3 and the structural unit derived from the compound represented by Chemical Formula 4 may be 1.1:1 to 9:1, 1.1:1 to 8:1, 1.1:1 to 7:1, 1.1:1 to 6:1, 1.5:1 to 8:1, 1.5:1 to 7:1, or 1.5:1 to 6:1. To the polyamideimide precursor composition according to an exemplary embodiment, TPC is added in an amount in excess of IPC, thereby implementing a low retardation in the thickness direction and also realizing excellent tensile strength and the like. Accordingly, optical properties and mechanical properties which are equivalent to or better than those of tempered glass may be implemented.

A mole ratio between the structural unit derived from a dianhydride and the structural unit derived from a diacid dichloride included in the polyamideimide precursor composition according to an exemplary embodiment may be 5:95 to 95:5, or for example, 5:95 to 80:20, 10:90 to 60:40, 5:95 to 50:50, 5:95 to 40:60, 10:90 to 40:60, or 5:95 to 35:65. However, the mole ratio is not necessarily limited thereto. The dianhydride may be specifically the compound represented by Chemical Formula 2, and the diacid dichloride may be specifically the compound represented by Chemical Formula 3 and the compound represented by Chemical Formula 4.

The structural unit derived from a diacid dichloride included in the polyamideimide precursor composition according to an exemplary embodiment may be included, for example, at 5 mol % to 95 mol %, at 20 mol % to 95 mol %, at 40 mol % to 90 mol %, at 50 mol % to 95 mol %, at 60 mol % to 95 mol %, at 60 mol % to 90 mol %, or at 65 mol % to 95 mol %, based on 100 mol % of the structural unit derived from a diamine, but is not necessarily limited thereto. The diamine may be specifically the compound represented by Chemical Formula 1, and the diacid dichloride may be specifically the compound represented by Chemical Formula 3 and the compound represented by Chemical Formula 4

In addition, the diamine may be used in combination with one or two or more selected from p-phenylenediamine (p-PDA), m-phenylenediamine (m-PDA), 4,4′-oxydianiline (4,4′-ODA), 3,4′-oxydianiline (3,4′-ODA), 2,2-bis(4-[4-aminophenoxy]-phenyl)propane (BAPP), 1,4-bis(4-aminophenoxy)benzene (TPE-Q), 1,3-bis(4-aminophenoxy)benzene (TPE-R), 4,4′-bis(4-aminophenoxy)biphenyl (BAPB), 2,2-bis(4-[4-aminophenoxy]phenyl)sulfone (BAPS), 2,2-bis(4-[3-aminophenoxy]phenyl)sulfone (m-BAPS), 3,3′-dihydroxy-4,4′-diaminobiphenyl (HAB), 3,3′-dimethylbenzidine (TB), 2,2′-dimethylbenzidine (m-TB), 2,2′-bis(trifluoromethyl)benzidine (TFMB), 1,4-bis(4-amino-2-trifluoromethylphenoxy)benzene (6FAPB), 2,2′-bis(trifluoromethyl)-4,4′-diaminodiphenylether (6FODA), 1,3-bis(3-aminophenoxy)benzene (APB), 1,4-naphthalenediamine (1,4-ND), 1,5-naphthalenediamine (1,5-ND), 4,4′-diaminobenzanilide (DABA), 6-amino-2-(4-aminophenyl)benzoxazole, 5-amino-2-(4-aminophenyl)benzoxazole, and the like, if necessary, but is not limited thereto.

In addition, the dianhydride may further include pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), 2,2-bis-(3,4-dicarboxylphenyl) hexafluoropropane dianhydride (6FDA), p-phenylenebistrimellitic monoester anhydride (TMHQ), 2,2-bis(4-hydroxyphenyl)propanedibenzoate-3,3′,4,4′-tetracarboxylic dianhydride (ESDA), naphthalenetetracarboxylic dianhydride (NTDA), or a combination thereof.

In addition, the diacid dichloride may further include 1,1′-biphenyl-4,4′-dicarbonyl dichloride (BPC), 1,4-naphthalenedicarboxylic dichloride (NPC), 2,6-naphthalenedicarboxylic dichloride (NTC), 1,5-naphthalenedicarboxylic dichloride (NEC), or a combination thereof, if necessary.

The polyamideimide precursor composition according to an exemplary embodiment may further include a mixed solvent including an amide-based solvent and a hydrocarbon-based solvent. The polyamideimide precursor composition further including the mixed solvent according to an exemplary embodiment may satisfy the following Equation 1. Without being bound to a certain theory, the polyamideimide precursor composition satisfying the conditions as such may be advantageous for application to a thin film process at the time of film formation, may inhibit a packing density of a polyamideimide film at the time of curing, and may make the film amorphous, thereby improving optical properties.

6,000≤V_{PAI}≤14,000 [Equation 1]

wherein

V_{PAI} is a viscosity of the polyamideimide precursor composition when a solid content is 17 wt % with respect to a total weight of the polyamideimide precursor composition, and the viscosity is a viscosity (unit: cp) measured based on 80% torque for 2 minutes using a 52Z spindle at 25° C. with a Brookfield rotational viscometer.

The viscosity (V_{PAI}) of the polyamideimide precursor composition according to an exemplary embodiment may be 7,000 cp to 14,000 cp, 8,000 cp to 14,000 cp, 9,000 cp to 14,000 cp, 9,500 cp to 14,000 cp, or 14,000 cp or less. Accordingly, the polyamideimide precursor composition including a high solid content may be applied to a thin film process more easily, and a polyamideimide film having better colorless and transparent performance, optical properties, and thermal resistance may be provided. Here, the solid content may be the polyamic acid and/or the polyamideimide.

The polyamideimide precursor composition according to an exemplary embodiment may include a non-polar solvent which may not be used as a polymerization solvent of a polyamic acid (hereinafter, also referred to as a polyamideimide precursor) and/or a polyamideimide, and hardly has compatibility with a polyamideimide, thereby improving both optical properties and thermal resistance. Specifically, the polyamideimide precursor composition according to an exemplary embodiment may include a polyamideimide precursor (polyamic acid and/or polyamideimide); a polar solvent; and a non-polar solvent. The polar solvent may be a hydrophilic solvent, for example, may be compatible with a polyamic acid and/or a polyamideimide, and for example, may be an amide-based solvent. In addition, the non-polar solvent may be hardly compatible with a polyamic acid and/or polyamideimide, and for example, may be a hydrocarbon-based solvent.

The polyamideimide precursor composition according to an exemplary embodiment uses a mixed solvent including an amide-based solvent and a hydrocarbon-based solvent, thereby more effectively inhibiting an intermolecular interaction between polymers and/or an interaction between a polymer and a solvent, and significantly decreasing an intermolecular packing density during curing, so that both optical properties and thermal resistance may be more improved. Furthermore, by using the mixed solvent, the polyimide precursor composition may lower the viscosity of the composition while having a high solid content. Thus, the polyamideimide precursor composition according to an exemplary embodiment includes a high solid content and a low viscosity, thereby forming a thin film more easily by a solution process, and providing a composition for forming a polyamideimide film having an excellent yellow index without deteriorating mechanical properties and thermal resistance.

In an exemplary embodiment, the amide-based solvent refers to a compound including an amide moiety. The amide-based solvent may be a cyclic compound or a chain compound, and specifically, may be a chain compound. The chain compound may have 2 to 15 carbon atoms, and more specifically, 3 to 10 carbon atoms. The amide-based solvent may include a N,N-dialkylamide moiety, and the dialkyl groups may be present independently of each other or be fused with each other to form a ring, or at least one alkyl group of the dialkyl groups is fused with other substituents in the molecule to form a ring, and for example, at least one alkyl group of the dialkyl groups may be fused with an alkyl group connected to a carbonyl carbon of an amide moiety to form a ring. Here, the ring may be 4-membered to 7-membered rings, for example, 5-membered to 7-membered rings, and for example, a 5-membered or 6-membered ring. The alkyl group may be a C₁₋₁₀ alkyl group, for example, a C₁₋₈ alkyl group, and for example, methyl, ethyl, or the like. More specifically, the amide-based solvent is not limited as long as it is commonly used in polyamic acid polymerization, but for example, may include dimethylpropionamide, diethylpropionamide, dimethylacetylamide, diethylacetamide, dimethylformamide, methylpyrrolidone, ethylpyrrolidone, octylpyrrolidone, or a combination thereof, and specifically, may include dimethylpropionamide.

In an exemplary embodiment, the hydrocarbon-based solvent may be a non-polar molecule, as described above. The hydrocarbon-based solvent may be a compound formed of carbon and hydrogen. For example, the hydrocarbon-based solvent may be aromatic or aliphatic, and for example, may be a cyclic compound or a chain compound, but specifically, may be a cyclic compound. Here, when the hydrocarbon-based solvent is a cyclic compound, it may include a monocycle or a polycycle, and the polycycle may be a condensed ring or a non-condensed ring, but specifically a monocyclic hydrocarbon-based solvent may be used. The hydrocarbon-based solvent may have 3 to 15 carbon atoms, for example, 6 to 15 carbon atoms, and for example, 6 to 12 carbon atoms. The hydrocarbon-based solvent may be a substituted or unsubstituted C₃₋₁₅ cycloalkane, a substituted or unsubstituted C₆₋₁₅ aromatic compound, or a combination thereof. Here, the cycloalkane may include cyclobutane, cyclopentane, cyclohexane, cycloheptane, cyclooctane, or a combination thereof, and the aromatic compound may include benzene, naphthalene, or a combination thereof. The hydrocarbon-based solvent may be cycloalkane which is unsubstituted or substituted with at least one C₁₋₅ alkyl group, an aromatic compound which is unsubstituted or substituted with at least one C₁₋₅ alkyl group, or a combination thereof, and each of the cycloalkane and the aromatic compound may be as described above. The C₁₋₅ alkyl group may be, for example, a C₁₋₃ alkyl group, for example, a C₁₋₂ alkyl group, and more specifically, a methyl group, but is not limited thereto. In addition, the hydrocarbon may further include oxygen, if necessary. For example, when the hydrocarbon-based solvent includes oxygen, it may include a ketone group or a hydroxyl group, and for example, may be cyclopentanone, cresol, or a combination thereof. Specifically, the hydrocarbon-based solvent may include benzene, toluene, cyclohexane, cyclopentanone, cresol, or a combination thereof, but is not limited thereto.

In an exemplary embodiment, the polyamideimide precursor composition may include a mixed solvent including an amide-based solvent including dimethylpropionamide and a hydrocarbon-based solvent selected from toluene, benzene, cyclohexane, and the like.

The hydrocarbon-based solvent according to an exemplary embodiment may be added after polyamic acid or polyamideimide polymerization.

The polyimide precursor composition according to an exemplary embodiment may show intermolecular behavior and interaction which are different from those when simply adding a mixed solution in a step of polymerizing a polyamic acid. For example, when in the step of polymerizing a polyamic acid, the hydrocarbon-based solvent is mixed, it acts as a factor inhibiting polymerization, so that a high molecular weight polyamic acid may not be obtained. However, in the polyimide precursor composition according to an exemplary embodiment, the hydrocarbon-based solvent is mixed after obtaining sufficient high molecular weight polyamic acid and/or polyamideimide, thereby acting as a catalyst which weakens an intermolecular interaction between polymers and/or a strong interaction between a polymer and a solvent, and obtaining desired optical properties in later curing. Here, by using the amide-based solvent and the hydrocarbon-based solvent sequentially, an interaction between the polyamic acid which is a polyamideimide precursor and the solvent may be adjusted to a more appropriate range. Here, the adjustment may refer to inhibition.

The hydrocarbon-based solvent included in the polyamideimide precursor composition according to an exemplary embodiment may be included at 5 wt % to 100 wt %, and for example, 10 wt % to 100 wt %, 15 wt % to 100 wt %, 20 wt % to 100 wt %, 20 wt % to 90 wt %, or 35 wt % to 85 wt %, with respect to the weight of the amide-based solvent. By having the weight relationship, the amide-based solvent and the hydrocarbon-based solvent may implement better optical properties, and also maintain the reactivity of diamine and dianhydride excellent, and when the polyamideimide precursor composition is cured, may appropriately inhibit an intermolecular packing density and make it amorphous. Accordingly, a polyamideimide film which has a further improved yellow index without deteriorating thermal resistance and mechanical properties may be provided.

A weight average molecular weight (Mw) of the polyamideimide included in the polyamideimide precursor composition according to an exemplary embodiment is not particularly limited, but may be 10,000 g/mol or more, specifically, 20,000 g/mol or more, and more specifically, 25,000 g/mol to 80,000 g/mol. By having the weight average molecular weight in the range described above, a film having better optical properties and mechanical strength, and less curl may be provided.

A solid content of the polyamideimide precursor composition according to an exemplary embodiment may satisfy a range of 40 wt % or less, 10 wt % to 40 wt %, 35 wt % or less, 30 wt % or less, 10 wt % to 25 wt %, or 15 wt % to 25 wt %, based on the total weight of the polyamideimide precursor composition, and the remainder may be an organic solvent. Here, the solid content may be the polyamic acid and/or the polyamideimide. Since the polyamideimide precursor composition has a low viscosity even with the solid content in the above range, a process advantage may be provided. Usually, since an absolute value of a retardation in the thickness direction and mechanical properties such as a modulus are in a trade-off relationship, it was difficult to improve both of the physical properties, but the polyamideimide film according to an exemplary embodiment may improve both of the physical properties.

Usually, since a polyamideimide has a higher viscosity with a higher solid content, for example, when the polyamic acid and/or the polyamideimide is dissolved in a common amide-based solvent alone, the viscosity of the solution is as high as about 15,000 cp or more. Here, the viscosity of the solution refers to a viscosity when a solid content is 17 wt % with respect to the total weight of the solution. In the case in which a thin film is produced by a solution process, for example, a coating process, when a polymer flow is not good due to a high viscosity, it is difficult to remove bubbles and Mura may occur during coating. However, the polyamideimide precursor composition according to an exemplary embodiment may significantly lower the viscosity of the composition even when including a high solid content of 17 wt % or more. Accordingly, defects occurring in a solution process, for example, a coating process may be effectively prevented, thereby implementing more improved optical properties. Besides, since it has a high solid content without defects occurring in the coating process, it may be commercially advantageous.

Hereinafter, the polyamideimide film according to one embodiment will be described.

The polyamideimide film according to one embodiment may be formed from the polyamideimide precursor composition according to an exemplary embodiment.

The polyamideimide film according to an exemplary embodiment is formed from the polyamideimide precursor composition according to an exemplary embodiment, thereby including a structural unit derived from a diamine, a structural unit derived from a dianhydride, and a structural unit derived from a diacid dichloride, and specifically, the structural unit derived from a diamine may include a structural unit derived from a compound represented by the following Chemical Formula 1; the structural unit derived from a dianhydride may include a structural unit derived from a compound represented by the following Chemical Formula 2; and the structural unit derived from a diacid dichloride may include a structural unit derived from a compound represented by the following Chemical Formula 3 and a structural unit derived from a compound represented by the following Chemical Formula 4.

The polyamideimide film according to an exemplary embodiment includes the structural units derived from the compounds represented by Chemical Formulae 1 to 4, respectively, thereby having excellent transparency and lowering distortion by light. In addition, the polyamideimide film may have excellent optical properties, such as significantly improving rainbow Mura in which an iridescent stain is formed when viewed at various angles, as compared with a conventional polyamideimide film. In addition, by including the structural units derived from the compounds represented by Chemical Formulae 1 to 4, respectively, the polyamideimide film according to an exemplary embodiment may have more improved distortion by light than a polyamideimide film including a polyamideimide polymer formed of a rigid structure. For example, in the polyamideimide film according to an exemplary embodiment, the structural unit derived from a dianhydride may not include a rigid structural unit. For example, it may not include a structural unit derived from a dianhydride in which two anhydride groups are fused to one ring. The ring may be a single ring or a fused ring, and may be an aromatic ring, an aliphatic ring, or a combination thereof. Specifically, the structural unit derived from a dianhydride may not include a structural unit derived from pyromellitic dianhydride (PMDA), a structural unit derived from cyclobutane-1,2,3,4-tetracarboxylic dianhydride (CBDA), or a combination thereof.

Accordingly, the polyamideimide film according to an exemplary embodiment may be transparent and implement a low retardation in the thickness direction even at a thickness of 30 μm or more, and may further improve visibility, and thus, a cover window including the polyamideimide film may reduce user's eye strain. In addition, since the polyamideimide film has more improved mechanical strength such as a modulus as well as excellent optical properties as described above even at the thickness of 30 μm or more, it has more improved dynamic bending properties and may be appropriate for application as a cover window of a foldable display device or a flexible display device in which folding and unfolding motions are repeated.

The polyamideimide film according to an exemplary embodiment may have a modulus in accordance with ASTM E111 of 4.0 GPa or more. Otherwise, for example, it may have a modulus of 4.0 GPa to 6.0 GPa, 4.5 GPa to 6.0 GPa, 4.0 GPa to 5.5 GPa, 4.5 GPa to 5.5 GPa, 5.0 GPa to 6.0 GPa, or 5.0 GPa to 5.5 GPa, but the modulus of the polyamideimide film according to an exemplary embodiment is not necessarily limited to the value in the above limited range.

The polyamideimide film according to an exemplary embodiment may have an absolute value of a retardation in the thickness direction (Rₜₕ) at a wavelength of 550 nm of 1000 nm or less. Otherwise, the value may be 500 nm to 1000 nm, 600 nm to 1000 nm, 800 nm to 1000 nm, or 900 nm to 1000 nm, but the retardation value in the thickness direction of the polyamideimide film according to an exemplary embodiment is not necessarily limited to the above limited range. The retardation value in the thickness direction may be measured at normal temperature before heating the film, and the normal temperature may be a temperature in a state of being not artificially adjusted. For example, the normal temperature may be 20° C. to 40° C., 20° C. to 30° C., or 23° C. to 26° C.

The polyamideimide film according to an exemplary embodiment may satisfy both the modulus and the retardation in the thickness direction, and thus, may provide enough mechanical properties, durability, and optical properties to be applied to a cover window for a display.

The polyamideimide film according to an exemplary embodiment may have a yellow index (YI) in accordance with ASTM E313 of 4.0 or less. Otherwise, the yellow index may be 3.8 or less, 3.5 or less, 1.0 or more and 4.0 or less, 1.0 or more and 3.8 or less, 1.5 or more and 3.8 or less, 2.0 or more and 4.0 or less, 2.5 or more and 3.8 or less, 2.8 or more and 4.0 or less, or 2.5 or more and 4.0 or less, but is not necessarily limited thereto.

The polyamideimide film according to an exemplary embodiment may have an elongation at break of 10% or more. Otherwise, for example, the elongation at break may be 11% or more, 13% or more, 14% or more, 10% or more and 20% or less, 10% or more and 17% or less, or 12% or more and 17% or less, but is not necessarily limited thereto.

The polyamideimide film according to an exemplary embodiment may have a thickness of 30 μm to 80 μm, 40 μm to 80 μm, 40 μm to 60 μm, or 50 μm to 80 μm.

The polyamideimide film according to an exemplary embodiment satisfies the retardation in the thickness direction, the yellow index, and/or the modulus in the ranges described above, thereby preventing image distortion by light to impart more improved visibility. In addition, more uniform mechanical properties (such as modulus) and optical properties (such as a retardation in the thickness direction) may be shown overall in the center and on the edge of the film, and a film loss may be further decreased. In addition, since the polyamideimide film is flexible and has excellent bending properties, the film may be more easily restored to its original form without deformation and/or damage even when predetermined deformation occurs repeatedly. In addition, a cover window including the polyamideimide film according to an exemplary embodiment may have better visibility, and prevent occurrence of fold marks and microcracks, and thus, may impart better durability and long life properties to a foldable display device or a flexible display device.

To the mol % and the mole ratio included in the polyamideimide film according to an exemplary embodiment, the above description may be applied as it is.

Hereinafter, a method for producing a polyamideimide film according to one embodiment will be described.

The method for producing a polyamideimide film according to one embodiment may include applying the polyamideimide precursor composition according to an exemplary embodiment to a substrate and then performing a heat treatment.

In the method for producing a polyamideimide film according to an exemplary embodiment, the heat treatment in the heat treatment step may be performed at a temperature of 280° C. or higher and 350° C. or lower for 10 minutes to 60 minutes. When curing is performed at a relatively low temperature, thermal hysteresis is less applied to the film, and thus, the yellow index tends to be relatively lowered, but when curing is performed at a glass transition temperature (Tg) or lower, the retardation in the thickness direction may be increased due to the orientation problem of a molecular structure. The polyamideimide film according to an exemplary embodiment is heat-treated at a temperature of 280° C. to 350° C. or 300° C. to 350° C., thereby arranging polymer chains to be more isotropic to decrease the retardation in the thickness direction. In addition, the heat treatment may be performed for example, for 10 minutes to 50 minutes, 10 minutes to 40 minutes, 10 minutes to 30 minutes, or 10 minutes to 20 minutes, but is not necessarily limited thereto. In addition, the thermal curing may be performed, for example, in a separate vacuum oven or an oven and the like filled with inert gas.

In addition, a drying step may be further performed before the heat treatment step, if necessary. The drying step may be performed at a temperature of 50° C. to 150° C., 50° C. to 130° C., 60° C. to 100° C., or about 80° C., but is not necessarily limited thereto.

The method for producing a polyamideimide film according to an exemplary embodiment may further include a standing step of applying the polyamideimide precursor composition on a substrate, and then allowing it to stand at normal temperature, if necessary. The optical properties on the film surface may be maintained more stably by the standing step. Without being bound to a certain theory, when a conventional polyamideimide precursor composition (or composition for forming a polyamideimide film) is subjected to the standing step as such before curing, the solvent absorbs moisture in the air, and the moisture diffuses inside and collides with polyamic acid and/or polyamideimide, so that cloudiness occurs from the film surface and agglomeration occurs to cause coating unevenness. However, the polyamideimide precursor composition according to an exemplary embodiment has no cloudiness and agglomeration even when allowed to stand in the air for a long time, and may secure a film having improved optical properties. The standing step may be performed at normal temperature and/or in a high humidity condition. Here, the normal temperature may be 40° C. or lower, for example, 30° C. or lower, for example, 25° C. or lower, more specifically, 15° C. to 25° C., and particularly preferably, 20° C. to 25° C. In addition, the high humidity may be a relative humidity of 50% or more, for example, 60% or more, for example, 70% or more, or for example, 80% or more. The standing step may be performed for 1 minute to 3 hours, for example, for 10 minutes to 2 hours, or for example, for 20 minutes to 1 hour.

In the method for producing a polyamideimide film according to an exemplary embodiment, the polyamideimide precursor composition may be mixed with one or two or more additives selected from a flame retardant, an adhesive strength improver, inorganic particles, an anti-oxidant, a UV blocking agent, a plasticizer, and the like to produce the polyamideimide film.

In addition, in the method for producing a polyamideimide film according to an exemplary embodiment, the application for forming the polyamideimide film may be used without a limitation as long as it is commonly used in the art. A non-limiting example thereof may include knife coating, dip coating, roll coating, slot die coating, lip die coating, slide coating, curtain coating, and the like, and the same or different kinds of application may be sequentially applied once or more thereto, of course.

The substrate may be used without a limitation as long as it is commonly used in the art, and a non-limiting example thereof includes glass; stainless steel; plastic films such as polyethylene terephthalate, polyethylene naphthalate, polypropylene, polyethylene, cellulose triacetate, cellulose diacetate, poly(meth)acrylic acid alkyl ester, poly(meth)acrylic acid ester copolymer, polyvinyl chloride, polyvinyl alcohol, polycarbonate, polystyrene, cellophane, polyvinylidene chloride copolymer, polyamide, polyimide, vinyl chloride/vinyl acetate copolymer, polytetrafluoroethylene, and polytrifluoroethylene; and the like.

Hereinafter, a method for producing the polyamideimide precursor composition according to one embodiment will be described.

The polyamideimide precursor composition according to one embodiment may be produced by a method including:

mixing a diamine including the compound represented by Chemical Formula 1 and a solvent to prepare a diamine solution (Step A); and

reacting the diamine solution with a dianhydride including the compound represented by Chemical Formula 2 and a diacid dichloride including the compound represented by Chemical Formula 3 and the compound represented by Chemical Formula 4 to prepare a polyamideimide precursor (Step B).

Regarding the production method according to an exemplary embodiment, the above detailed description may be applied thereto as it is.

In an exemplary embodiment, when the polyamideimide precursor composition includes a mixed solvent,

the composition may be produced by a method including: reacting a diamine including the compound represented by Chemical Formula 1, a dianhydride including the compound represented by Chemical Formula 2, and a diacid dichloride including the compound represented by Chemical Formula 3 and the compound represented by Chemical Formula 4 under an amide-based solvent to prepare a polyamic acid solution (step i); and

adding a hydrocarbon-based solvent (step ii).

In an exemplary embodiment, the step ii may be a step of adjusting viscosity by adding the hydrocarbon-based solvent so that the following Equation 1 is satisfied.

6,000≤V_{PAI}≤14,000 [Equation 1]

wherein

V_{PAI} is a viscosity of the polyamideimide precursor composition when a solid content is 17 wt % with respect to a total weight of the polyamideimide precursor composition, and the viscosity is a viscosity (unit: cp) measured based on 80% torque for 2 minutes using a 52Z spindle at 25° C. with a Brookfield rotational viscometer.

The step i according to an exemplary embodiment is a step of mixing the diamine, the dianhydride, and the diacid dichloride to polymerize a polyamic acid, and may include dissolving the diamine under an amide-based solvent, adding and dissolving the diacid dichloride, adding and dissolving the dianhydride, and stirring the reaction solution for 5 hours to 7 hours to perform the reaction.

The step ii according to an exemplary embodiment may be a step of further adding the hydrocarbon solvent described above, performing stirring, and then further adding a mixed solvent of the amide-based solvent and the hydrocarbon-based solvent, whereby the viscosity range of the polyamideimide precursor composition may satisfy Equation 1. Specifically, the step ii includes further adding 5 wt % to 100 wt %, for example, 10 wt % to 100 wt %, 15 wt % to 100 wt %, 20 wt % to 100 wt %, 20 wt % to 90 wt %, or 35 wt % to 85 wt % of a hydrocarbon-based solvent with respect to the weight of the amide-based solvent of the step i at room temperature (25° C.), and performing stirring for 15 hours to 20 hours; and after completing the stirring, adding a mixed solvent including the amide-based solvent and the hydrocarbon-based solvent so that Equation 1 is satisfied. Without being bound to a certain theory, the polyamideimide precursor composition satisfying the conditions may inhibit the packing density of the polyamideimide film and make the film amorphous. Accordingly, a polyamideimide film having a further improved yellow index without deteriorating mechanical properties and thermal resistance may be provided.

In addition, the polyimide precursor composition according to an exemplary embodiment may show intermolecular behavior and interaction which are different from those when simply adding a mixed solution in a step of polymerizing a polyamic acid. For example, when the hydrocarbon-based solvent is included in the step of polymerizing a polyamic acid, it acts as a factor inhibiting polymerization, so that a high molecular weight polyamic acid may not be obtained. However, in the polyamideimide precursor composition according to an exemplary embodiment, the polyamic acid and/or polyamideimide having a sufficiently high molecular weight is/are obtained, and then the hydrocarbon-based solvent is mixed therewith, thereby obtaining a high molecular weight polyamic acid. In addition, the hydrocarbon-based solvent may act as a catalyst which weakens an interaction between polymers and/or a strong interaction between a polymer and a solvent, and in later curing, desired optical properties may be obtained.

Hereinafter, a use of the polyamideimide film according to one embodiment will be described.

An aspect of the use of the polyamideimide film according to one embodiment may be a multilayer structure including the polyamideimide film according to an exemplary embodiment. For example, it may be a cover window for a display device including the polyamideimide film; and a coating layer placed on the polyamideimide film. In addition, the multilayer structure may include a polyamideimide film including monomers having compositions different from the polyamideimide film according to an exemplary embodiment, and two or more coating layers.

Here, a non-limiting example of the coating layer may be a hard coating layer, an antistatic layer, an anti-fingerprint layer, an antifouling layer, a scratch-resistant layer, a low-refractive index layer, an anti-reflection layer, a shock absorbing layer, or a combination thereof, but is not necessarily limited thereto. Here, the thickness of the coating layer may be 1 μm to 500 μm, 2 μm to 450 μm, or 2 μm to 200 μm, but is not limited thereto.

The multilayer structure according to an exemplary embodiment may include the polyamideimide film according to an exemplary embodiment formed on the substrate and a semiconductor layer. A non-limiting example of the semiconductor layer may include low-temperature polysilicon (LTPS), low-temperature polycrystalline oxide (LTPO), indium tin oxide (ITO), indium gallium zinc oxide (IGZO), and the like, and for example, may include LTPS and/or LTPO. A display device using low-temperature polysilicon (LTPS) and/or low-temperature polycrystalline oxide (LTPO) may have a process temperature approaching 350° C. or higher and 500° C. or lower. In the high-temperature process as such, even polyamideimide having excellent thermal resistance easily undergoes thermal decomposition by hydrolysis. Therefore, for producing a flexible device for LTPS and/or LTPO, a material having excellent thermal resistance which does not undergo thermal decomposition by hydrolysis even in a high-temperature process is demanded. The polyamideimide film according to an exemplary embodiment has both excellent optical properties and excellent thermal resistance, so that it may be used in a display device for LTPS and/or LTPO.

Another embodiment may be a display device including the polyamideimide film according to an exemplary embodiment.

As described above, the polyamideimide film according to an exemplary embodiment has excellent optical properties and mechanical properties, and specifically, may show a sufficient retardation at various angles, and thus, may be applied in various industrial fields required to secure a wide viewing angle.

As an example, the display device is not particularly limited as long as it belongs to a field requiring excellent optical properties, and may be provided by selecting a display panel appropriate therefor. Specifically, it may be applied to a flexible display device, and a non-limiting example thereof may include various image display devices such as a liquid crystal display device, an electroluminescence display device, a plasma display device, and a field emission display device, and the like, but is not limited thereto.

The display device including the polyamideimide film according to an exemplary embodiment has excellent display quality to be displayed and also a significantly reduced distortion phenomenon by light, and thus, particularly, may significantly improve a rainbow phenomenon in which iridescent stains occur and minimize user's eye strain with excellent visibility. In particular, as a screen size of a display device is increased, the screen is often seen from the side, and when the polyamideimide film for a cover window according to one embodiment is applied to a display device, visibility is excellent even when seen from the side, and thus, the film may be usefully applied to a large display device.

Hereinafter, the examples and the experimental examples of one embodiment will be specifically illustrated. However, the examples and the experimental examples described below only illustrate a part of one embodiment, and one embodiment is not limited to the examples and the experimental examples.

In the following experimentation, the physical properties of the film were measured as follows.

<Measurement Method>

1. Retardation (Rₜₕ)

The retardation was measured using Axoscan (OPMF, Axometrics Inc.). The retardation in the thickness direction (Rₜₕ) to a wavelength of 550 nm was measured, and the retardation in the thickness direction at a wavelength of 550 nm was indicated as an absolute value. The unit is nm.

2. Yellow index (YI)

The yellow index was measured using a spectrophotometer (Nippon Denshoku, COH-5500) in accordance with the standard of ASTM E313.

3. Modulus and Elongation at Break

The modulus and the elongation at break were measured, using UTM 3365 available from Instron, under the condition of pulling a specimen having a thickness of 50 μm, a length of 50 mm, and a width of 10 mm at 25° C. at 50 mm/min, in accordance with ASTM E111. The unit of the modulus is GPa and the unit of the elongation at break is %.

4. Viscosity (V_{PAI})

0.5 uL of a polyamideimide precursor composition (solid content: 17 wt %) was put into a container with a Plate rheometer (Brookfield, LVDV-III Ultra), a spindle was lowered and rpm was adjusted, and after standby for 2 minutes when reaching a torque of 80%, a viscosity value when there was no torque change was measured. At this time, the viscosity was measured under the temperature condition of 25° C., using a 52Z spindle. The unit is cp.

### Example 1

Production of Polyamideimide Precursor Composition

N,N-dimethylpropionamide (DMPA) and 2,2′-Bis(trifluoromethyl)-benzidine (TFMB) were added to a reactor under a nitrogen atmosphere, stirring was sufficiently performed, terephthaloyl chloride (TPC) was added thereto, and stirring was performed for 6 hours to perform dissolution and the reaction. Thereafter, an excessive amount of methanol was used to perform precipitation and filtration to obtain a reaction product, which was dried under vacuum at 50° C. for 6 hours or more to obtain white powder. Next, TFMB and isophthaloyl chloride (IPC) were reacted under the same conditions as the above, stirring was performed for 6 hours, and precipitation and drying were performed in the same manner to obtain white powder. The obtained white powder was added with DMPA to the reactor under a nitrogen atmosphere and dissolved, 9,9-bis(3,4-dicarboxyphenyl)fluorene dianhydride (BPAF) was added, and then dissolution and reaction were performed while stirring was performed for 12 hours, thereby producing a polyamic acid resin composition. At this time, the mole ratio of each monomer is shown in the following Table 1, and the solid content was adjusted to 15 wt %, thereby producing a composition for forming a polyamideimide film as a polyamideimide precursor composition.

Production of Polyamideimide Film

The composition for forming a polyamideimide film obtained above was applied on one surface of a glass substrate (1.0 T) with a mayer bar, dried at 80° C. for 15 minutes under a nitrogen atmosphere, cured by heating at 300° C. for 15 minutes, and peeled off from the glass substrate to produce a polyamideimide film having a thickness of 50 μm.

### Examples 2 to 5

Each of the polyamideimide precursor compositions of Examples 2 to 5 was produced in the same manner as in Example 1, except that the mole ratios of TFMB, BPAF, TPC, and IPC were changed as shown in Table 1, and each of the polyamideimide films of Examples 2 to 5 having a thickness of 50 μm was produced in the same manner as in Example 1.

### Comparative Example 1

The polyamideimide precursor composition of Comparative Example 1 was produced in the same manner as in Example 1, except that 2,5-furandicarbonyl dichloride (FDCAC1) was used instead of TPC, and the polyamideimide film of Comparative Example 1 having a thickness of 50 μm was produced in the same manner as in Example 1.

TABLE 1

| | TEMB | BPAF | TPC | IPC | FDCAC1 |
|---|---|---|---|---|---|
| Example 1 | 100 | 29 | 60 | 11 | |
| Example 2 | 100 | 25 | 60 | 15 | |
| Example 3 | 100 | 20 | 48 | 32 | |
| Example 4 | 100 | 20 | 40 | 40 | |
| Example 5 | 100 | 41 | 12.5 | 46.5 | |
| Comparative | 100 | 29 | | 11 | 60 |
| Example 1 | | | | | |

### <Experimental Example 1> Evaluation of Optical Properties and Mechanical Properties

The modulus, the retardation in the thickness direction (Rₜₕ), the yellow index (YI), and the elongation at break of the polyamideimide films according to Examples 1 to 5 and Comparative Example 1 were measured according to the above measurement methods, and are shown in the following Table 2:

TABLE 2

| | Example | | |
|---|---|---|---|
| | 1 | 2 | 3 |
| Thickness (μm) | 50 | 50 | 50 |
| Modulus (GPa) | 5.4 | 5.3 | 5.2 |
| Rₜₕ (550 nm) | 980 | 960 | 920 |
| Yellow index (YI) | 3.8 | 3.5 | 3.3 |
| Elongation at break (%) | 14 | 15 | 14 |
| | | | Comparative |
| | Example | | Example |
| | 4 | 5 | 1 |
| Thickness (μm) | 50 | 50 | 50 |
| Modulus (GPa) | 3.8 | 3.5 | 3.1 |
| Rₜₕ (550 nm) | 890 | 426 | 920 |
| Yellow index (YI) | 3.5 | 4.3 | 9 . 8 |
| Elongation at break (%) | 11 | 10.2 | 8 |

As confirmed in Table 2, Comparative Example 1 including no TPC as the diacid dichloride had decreased modulus and elongation at break as compared with the polyamideimide films of the examples and a significantly high yellow, and thus, was not appropriate for use as a polyamideimide film for a display.

### Example 6

Production of Polyamideimide Precursor Composition

N,N-dimethylpropionamide (DMPA) and 2,2′-Bis(trifluoromethyl)-benzidine (TFMB) were added to a reactor under a nitrogen atmosphere, stirring was sufficiently performed, terephthaloyl chloride (of TPC) was added thereto, and stirring was performed for 6 hours to perform dissolution and the reaction. Thereafter, an excessive amount of methanol was used to perform precipitation and filtration to obtain a reaction product, which was dried under vacuum at 50° C. for 6 hours or more to obtain white powder. Next, TFMB and isophthaloyl chloride (IPC) were reacted under the same conditions as the above, stirring was performed for 6 hours, and precipitation and drying were performed in the same manner to obtain white powder. The obtained powder was added to the reactor with DMPA under a nitrogen atmosphere and dissolved, 9,9-bis(3,4-dicarboxyphenyl)fluorene dianhydride (BPAF) was added, and dissolution and reaction were performed for 12 hours with stirring, thereby producing a polyamic acid resin composition. At this time, the mole ratio of each monomer is shown in Table 3.

Next, toluene was added thereto at 25° C., and stirring was performed for 18 hours. Thereafter, a mixed solvent of DMPA and toluene was added so that the solid content was 17 wt % based on the total weight of the composition and the content of toluene in the composition was DMPA:toluene=70 wt %:30 wt %, thereby producing a polyamideimide precursor composition. At this time, the mole ratio of each monomer is shown in Table 3.

Production of Polyamideimide Film

The polyamideimide precursor composition obtained above was applied on one surface of a glass substrate (1.0 T) with a mayer bar, dried at 80° C. for 15 minutes, cured by heating at 300° C. for 15 minutes, and peeled off from the glass substrate to produce the polyamideimide film according to Example 6 having a thickness of 50 μm.

### Examples 7 to 11 and Reference Examples 1 to 4

The polyamideimide precursor compositions of Examples 7 to 11 and Reference Examples 1 to 4 were produced in the same manner as in Example 6, except that the mole ratios of TFMB, BPAF, TPC, and IPC and the content of toluene were changed as shown in Table 3, and the polyamideimide films of Examples 7 to 11 and Reference Examples 1 to 4 having a thickness of 50 μm were produced in the same manner as in Example 6.

TABLE 3

| | TEMB | BPAF | TPC | IPC | Toluene (wt %) |
|---|---|---|---|---|---|
| Example 6 | 100 | 29 | 60 | 11 | 30 |
| Example 7 | 100 | 25 | 60 | 15 | 30 |
| Example 8 | 100 | 20 | 48 | 32 | 30 |
| Example 9 | 100 | 29 | 60 | 11 | 15 |
| Example 10 | 100 | 29 | 60 | 11 | 25 |
| Example 11 | 100 | 29 | 60 | 11 | 45 |
| Reference Example 1 | 100 | 29 | 60 | 11 | 60 |
| Reference Example 2 | 100 | 28 | 65 | 7 | 30 |
| Reference Example 3 | 100 | 20 | 40 | 40 | 30 |
| Reference Example 4 | 100 | 41 | 12.5 | 46.5 | 30 |

### <Experimental Example 2> Evaluation of Optical Properties and Mechanical Properties

The viscosity, the yellow index (YI), the retardation in the thickness direction (Rₜₕ), and the modulus of the polyamideimide films according to Examples 6 to 11 and Reference Examples 1 to 4 were measured according to the above measurement methods, and are shown in the following Table 4:

TABLE 4

| | Example | | | | | |
|---|---|---|---|---|---|---|
| | 6 | 7 | 8 | 9 | 10 | 11 |
| Thickness (μm) | 50 | 50 | 50 | 50 | 50 | 50 |
| Viscosity (V_{PAI}, | 12,500 | 11,000 | 9,800 | 14,000 | 13,800 | 11,300 |
| cp) | | | | | | |
| Yellow index (YI) | 3.5 | 3.3 | 3.0 | 3.3 | 3.6 | 3.5 |
| Rₜₕ (550 nm) | 960 | 940 | 905 | 920 | 965 | 950 |
| Modulus (GPa) | 5.2 | 5.1 | 5.1 | 5.2 | 5.3 | 5.2 |

| | Reference Example | | | |
|---|---|---|---|---|
| | 1 | 2 | 3 | 4 |
| Thickness (μm) | No | 50 | 50 | 50 |
| Viscosity (V_{PAI}, | polymerization | 17,500 | 11,300 | 9,800 |
| cp) | due to initial | | | |
| Yellow index (YI) | viscosity | 4.1 | 3.3 | 3.9 |
| Rₜₕ (550 nm) | increase | 1,070 | 800 | 403 |
| Modulus (GPa) | | 5.0 | 3.6 | 3.2 |

When the polyamideimide precursor composition according to one embodiment is used, a polyamideimide film having excellent optical properties and thermal resistance may be formed. Specifically, the polyamideimide film formed from the polyamideimide precursor composition according to one embodiment may significantly improve a Mura phenomenon causing deterioration of visibility, in particular, a rainbow phenomenon by retardation. In addition, colorless and transparent optical properties may be implemented even in a thickness range having mechanical strength similar to that of tempered glass. Furthermore, by having a low retardation in the thickness direction (Rₜₕ) in a wide visible light region, a reflection appearance may be significantly improved. At the same time, due to its excellent bending properties as well as high strength properties mentioned above, breakage or cracks due to bending may be prevented. Therefore, the polyamideimide film according to one embodiment may be usefully applied for an optical use such as a foldable display device or a flexible display device.

Since the above examples and the experimental examples were only provided to help the overall understanding of one embodiment, one embodiment is not limited to the exemplary embodiments, and various modifications and variations may be made by a person with ordinary skill in the art described in the present specification from the description.

Therefore, the spirit of one embodiment should not be limited to the above-described exemplary embodiments, and the following claims as well as all modified equally or equivalently to the claims are intended to fall within the scope and spirit of one embodiment.

1. A polyamideimide precursor composition comprising: a structural unit derived from a diamine, a structural unit derived from a dianhydride, and a structural unit derived from a diacid dichloride,
wherein the structural unit derived from a diamine includes a structural unit derived from a compound represented by the following Chemical Formula 1; the structural unit derived from a dianhydride includes a structural unit derived from a compound represented by the following Chemical Formula 2; and the structural unit derived from a diacid dichloride includes a structural unit derived from a compound represented by the following Chemical Formula 3 and a structural unit derived from a compound represented by the following Chemical Formula 4:

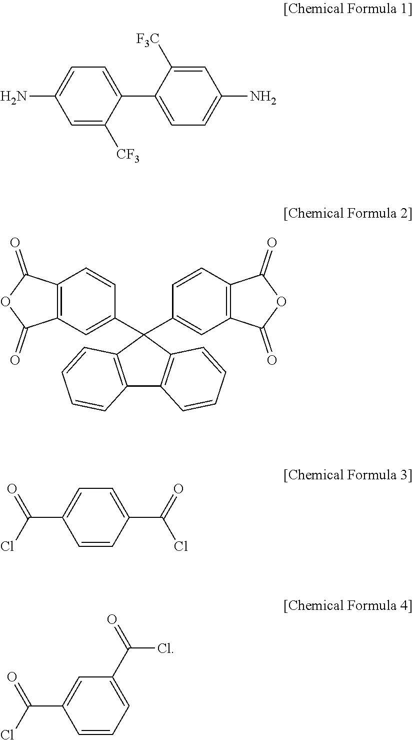

2. The polyamideimide precursor composition of claim 1, wherein the structural unit derived from the compound represented by Chemical Formula 3 is included in an amount of more than 50 mol % and less than 90 mol %, based on a total of 100 mol % of the structural unit derived from the compound represented by Chemical Formula 3 and the structural unit derived from the compound represented by Chemical formula 4.

3. The polyamideimide precursor composition of claim 1, wherein a mole ratio between the structural unit derived from a dianhydride and the structural unit derived from a diacid dichloride is 5:95 to 95:5.

4. The polyamideimide precursor composition of claim 1, wherein a solid content of the polyamideimide precursor composition is included at 10 wt % to 40 wt % with respect to a total weight of the polyamideimide precursor composition.

5. The polyamideimide precursor composition of claim 1, further comprising: a mixed solvent including an amide-based solvent and a hydrocarbon-based solvent.

6. The polyamideimide precursor composition of claim 5, wherein the following Equation 1 is satisfied:
6,000≤V_{PAI}≤14,000 [Equation 1]
wherein
V_{PAI} is a viscosity of the polyamideimide precursor composition when a solid content is 17 wt % with respect to a total weight of the polyamideimide precursor composition, and the viscosity is a viscosity (unit: cp) measured based on 80% torque for 2 minutes using a 52Z spindle at 25° C. with a Brookfield rotational viscometer.

7. The polyamideimide precursor composition of claim 5, wherein the amide-based solvent includes dimethylpropionamide.

8. The polyamideimide precursor composition of claim 5, wherein the hydrocarbon-based solvent is a cyclic hydrocarbon-based solvent.

9. The polyamideimide precursor composition of claim 8, wherein the cyclic hydrocarbon-based solvent includes toluene, benzene, cyclohexane, or a combination thereof.

10. The polyamideimide precursor composition of claim 5, wherein the hydrocarbon-based solvent is included at 5 wt % to 100 wt % with respect to a weight of the amide-based solvent.

11. A polyamideimide film formed from the polyamideimide precursor composition according to claim 1.

12. The polyamideimide film of claim 11, wherein the polyamideimide film has a modulus in accordance with ASTM E111 of 4.0 GPa or more, and an absolute value of a retardation in the thickness direction (Rₜₕ) at a wavelength of 550 nm of 1000 nm or less.

13. The polyamideimide film of claim 11, wherein the polyamideimide film has a thickness of 30 μm to 100 μm and a yellow index (YI) in accordance with ASTM E313 of 4.0 or less.

14. The polyamideimide film of claim 11, wherein the polyamideimide film has an elongation at break of 10% or more.

15. A method for producing a polyamideimide film, the method comprising: applying the polyamideimide precursor composition according to claim 1 on a substrate and then performing a heat treatment.

16. The method for producing a polyamideimide film of claim 15, wherein the heat treatment is performed at a temperature of 280° C. to 350° C. for 10 minutes to 60 minutes.

17. A method for producing the polyamideimide precursor composition of claim 5, the method comprising the steps of:
step (i) reacting a diamine including a compound represented by the following Chemical Formula 1, a dianhydride including a compound represented by the following Chemical Formula 2, and a diacid dichloride including a compound represented by the following Chemical Formula 3 and a compound represented by Chemical Formula 4 under an amide-based solvent to prepare a polyamic acid solution; and
step (ii) adding a hydrocarbon-based solvent:

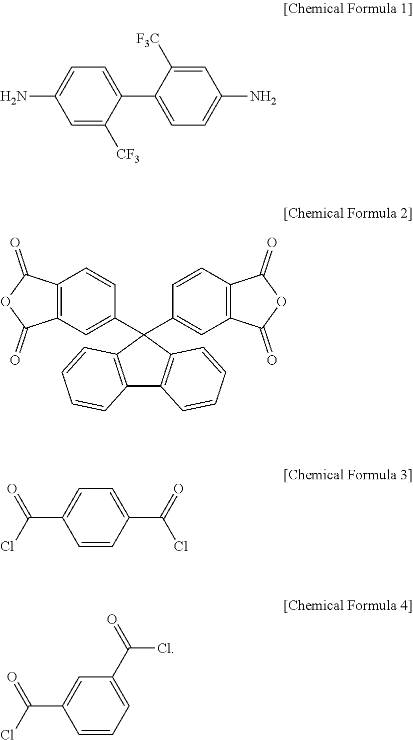 [SMILES: Nc1ccc(-c2ccc(N)cc2C(F)(F)F)c(C(F)(F)F)c1 ; O=C1OC(=O)c2cc(C3(c4ccc5c(c4)C(=O)OC5=O)c4ccccc4-c4ccccc43)ccc21 ; O=C(Cl)c1ccc(C(=O)Cl)cc1 ; O=C(Cl)c1cccc(C(=O)Cl)c1]

18. The method for producing a polyamideimide precursor composition of claim 17, wherein step (ii) includes:
adding 5 wt % to 100 wt % of the hydrocarbon-based solvent with respect to a weight of the amide-based solvent of step (i) and performing stirring; and
further adding a mixed solvent of the amide-based solvent and the hydrocarbon-based solvent.

19. The method for producing a polyamideimide precursor composition of claim 17, wherein step (ii) is adjusting viscosity by adding the hydrocarbon-based solvent so that the following Equation 1 is satisfied:
6,000≤V_{PAI}≤14,000 [Equation 1]
wherein
V_{PAI} is a viscosity of the polyamideimide precursor composition when a solid content is 17 wt % with respect to a total weight of the polyamideimide precursor composition, and the viscosity is a viscosity (unit: cp) measured based on 80% torque for 2 minutes using a 52Z spindle at 25° C. with a Brookfield rotational viscometer.

20. A display device comprising the polyamideimide film according to claim 11.
